(19) United States
(12) Patent Application Publication
(10) Pub. No.: US 2008/0086599 A1
(43) Pub. Date: Apr. 10, 2008

(54) METHOD TO RETAIN CRITICAL DATA IN A CACHE IN ORDER TO INCREASE APPLICATION PERFORMANCE

(76) Inventors: WILLIAM A. MARON, Austin, TX (US); Greg R. Mewhinney, Austin, TX (US); Mysore Sathyanarayana Srinivas, Austin, TX (US); David Blair Whitworth, Austin, TX (US)

Correspondence Address: IBM CORP (YA);C/O YEE & ASSOCIATES PC, P.O. BOX 802333, DALLAS, TX, 75380, US

(21) Appl. No.: 11/539,894

(22) Filed: Oct. 10, 2006

(51) Int. Cl. G06F 12/00

(52) U.S. Cl. 711/133

(57) ABSTRACT

A computer implemented method, apparatus, and computer usable program code for managing data in a cache. Data in the cache is identified that has been designated by an application to form identified data. The identified data is aged in the cache at a slower rate than other data in the cache that is undesignated for slower aging in response to identifying the data in the cache.

### BACKGROUND

1. Field of the Invention

The present invention relates generally to an improved data processing system and in particular to a computer implemented method and apparatus for processing data. Still more particularly, the present invention relates to a computer implemented method, apparatus, and computer usable program code for managing data in a cache.

2. Description of the Related Art

A cache is a section of memory used to store data that is used more frequently than those in storage locations that may take longer to access. Processors typically use caches to reduce the average time required to access memory. When a processor wishes to read or write a location in main memory, the processor first checks to see whether that memory location is present in the cache. If the processor finds that the memory location is present in the cache, a cache hit has occurred. Otherwise, a cache miss is present. As a result of a cache miss, a processor immediately reads or writes the data in the cache line. A cache line is a location in the cache that has a tag containing the index of the data in main memory that is stored in the cache. This cache line is also called a cache block.

A design problem currently facing processor development is memory latency. In many processor designs, the cycle time for data delivery from main memory to an execution unit could exceed 400 cycles. To help this problem, local level one (L1) and level two (L2) caches are used. Local level caches are subsets of memory used to help temporal and spatial locality of data, two common architecture problems.

Local memory contention and false sharing problems are introduced when operating systems employ environment techniques like multitasking and multithreading. These applications could cause a cache to thrash. This non-deterministic memory reallocation will decrease the efficiency of locality of data techniques, such as prefetch and castout.

Applications can be separated into three data pattern types: streaming, locking, and opportunistic. Streaming is data accessed sequentially, perhaps modified, and then never referred to again. Locking is especially associative data that may be referenced multiple times or after long periods of idle time. Allocation and replacement are usually handled by some random, round robin, or least recently used (LRU) algorithms. Software could detect the type of data pattern it is using and should use a resource management algorithm concept to help hardware minimize memory latencies. Software directed set allocation and replacement methods in a set associative cache will create “virtual” operating spaces for each application. A cache may divide a way into multiple sets for storing data in one of multiple ways for an entry. A way is also referred to as a set. Opportunistic describes random data accesses.

Pseudo-LRU (p-LRU) is an approximated replacement policy to keep track of the order in which lines within a cache congruence class are accessed, so that only the least recently accessed line is replaced by new data when there is a cache miss. For each cache access, the p-LRU is updated such that the last item accessed is now most recently used, and the second to least recently used now becomes the least recently used data.

Some software applications have critical data structures that need to be given preferential treatment to allow these data structures to stay in cache longer than normal for the application to achieve optimal performance. There is currently no way for an application to tell the cache which data structures are critical such that the cache could allow the data structures to stay in the cache longer than the LRU would normally allow.

### SUMMARY

The illustrative embodiments provide a computer implemented method, apparatus, and computer usable program code for managing data in a cache. Data in the cache is identified that has been designated by an application to form identified data. The identified data is aged in the cache at a slower rate than other data in the cache that is undesignated for slower aging in response to identifying the data in the cache.

### BRIEF DESCRIPTION OF THE DRAWINGS

The novel features believed characteristic of the illustrative embodiments are set forth in the appended claims. The illustrative embodiments themselves, however, as well as a preferred mode of use, further objectives and advantages thereof, will best be understood by reference to the following detailed description of the illustrative embodiments when read in conjunction with the accompanying drawings, wherein:

FIG. 1 is a block diagram of a data processing system in which the illustrative embodiments may be implemented;

FIG. 2 is a diagram illustrating a processor system in accordance with the illustrative embodiments;

FIG. 3 is a typical software architecture for a server-client system in accordance with the illustrative embodiments;

FIG. 4 is an exemplary cache priority table in accordance with the illustrative embodiments; and

FIG. 5 is a flowchart for a process for establishing cache priority information in accordance with the illustrative embodiments.

### DETAILED DESCRIPTION OF THE PREFERRED EMBODIMENT

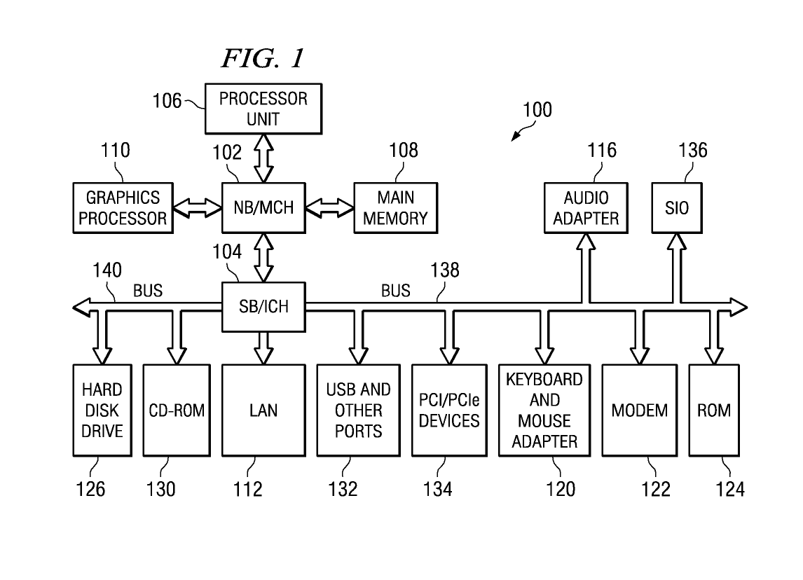

With reference now to FIG. 1, a block diagram of a data processing system is shown in which the illustrative embodiments may be implemented. Data processing system 100 is an example of a computer in which processes and an apparatus of the illustrative embodiments may be located. In the depicted example, data processing system 100 employs a hub architecture including a north bridge and memory controller hub (MCH) 102 and a south bridge and input/output (I/O) controller hub (ICH) 104. Processor unit 106, main memory 108, and graphics processor 110 are connected to north bridge and memory controller hub 102.

Graphics processor 110 may be connected to the MCH through an accelerated graphics port (AGP), for example. Processor unit 106 contains a set of one or more processors. When more than one processor is present, these processors may be separate processors in separate packages. Alternatively, the processors may be multiple cores in a package. Further, the processors may be multiple multi-core units.

An example of this type of processor is a Cell Broadband Engine™ processor, which is a heterogeneous processor. This process has a processor architecture that is directed toward distributed processing. This structure enables implementation of a wide range of single or multiple processor and memory configurations, in order to optimally address many different systems and application requirements. This type of processor can consist of a single chip, a multi-chip module (or modules), or multiple single-chip modules on a motherboard or other second-level package, depending on the technology used and the cost/performance characteristics of the intended implementation. A Cell Broadband Engine™ has a PowerPC Processor Element (PPE) and a number of Synergistic Processor Units (SPU). The PPE is a general purpose processing unit that can perform system management functions, like addressing memory-protection tables. SPUs are less complex computation units that do not have the system management functions. Instead, the SPUs provide computational processing to applications and are managed by the PPE.

In the depicted example, local area network (LAN) adapter 112 connects to south bridge and I/O controller hub 104 and audio adapter 116, keyboard and mouse adapter 120, modem 122, read only memory (ROM) 124, hard disk drive (HDD) 126, CD-ROM drive 130, universal serial bus (USB) ports and other communications ports 132, and PCI/PCIe devices 134 connect to south bridge and I/O controller hub 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to south bridge and I/O controller hub 104.

An operating system runs on processor unit 106 and coordinates and provides control of various components within data processing system 100 in FIG. 1. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 100 (Java is a trademark of Sun Microsystems, Inc. in the United States, other countries, or both).

Instructions for the operating system, the object-oriented programming system, and applications or programs are located on storage devices, such as hard disk drive 126, and may be loaded into main memory 108 for execution by processor unit 106. The processes of the illustrative embodiments are performed by processor unit 106 using computer implemented instructions, which may be located in a memory such as, for example, main memory 108, read only memory 124, or in one or more peripheral devices.

Those of ordinary skill in the art will appreciate that the hardware may vary depending on the implementation. Other internal hardware or peripheral devices, such as flash memory, equivalent non-volatile memory, or optical disk drives and the like, may be used in addition to or in place of the hardware. Also, the processes of the illustrative embodiments may be applied to a multiprocessor data processing system.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted examples in FIG. 1 are not meant to imply architectural limitations. For example, data processing system 100 also may be a tablet computer, laptop computer, or telephone device in addition to taking the form of a PDA.

The illustrative embodiments provide a computer implemented method, apparatus, and computer usable program code for managing data in a cache. A cache priority level or priority level is set for critical data structures within an application. The cache priority level is a designation, value, or other indicator that prolongs the time that the data of the critical data structures remains in the cache. In other words, the addresses of the critical data structures are aged more slowly to ensure that critical data remains cached longer. Critical data structures are data structures that are critical for the performance of the application. Critical data structures may include data that is frequently used or data that needs to be accessed efficiently at any given time. By keeping the data from the critical data structures in cache for prolonged amounts of time, the application is able to achieve optimal performance.

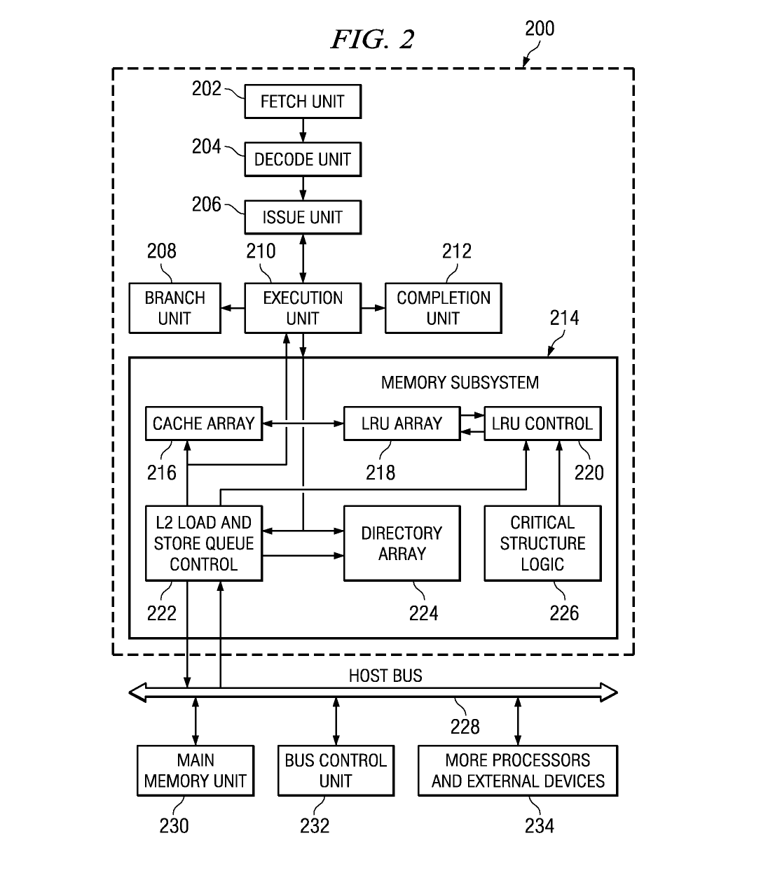

Turning now to FIG. 2, a diagram illustrating a processor system is depicted in accordance with the illustrative embodiments. Processor system 200 is an example of a processor that may be found in processor unit 106 in FIG. 1. In this example, processor system 200 contains fetch unit 202, decode unit 204, issue unit 206, branch unit 208, execution unit 210, and completion unit 212. Processor system 200 also contains memory subsystem 214. Memory subsystem 214 contains cache array 216, least recently used (LRU) array 218, LRU control 220, L2 load and store queue control 222, directory array 224, and critical structure logic 226. Processor system 200 connects to host bus 228. Additionally, main memory unit 230, bus control unit 232, and more processors and external devices 234 also connect to host bus 228.

In these examples, fetch unit 202 fetches instructions from memory subsystem 214 or main memory unit 230 to speed up execution of a program. Fetch unit 202 retrieves an instruction from memory before that instruction is needed to avoid the processor having to wait for the memory, such as memory subsystem 214 or main memory unit 230 to answer a request for the instruction. Decode unit 204 decodes an instruction for execution. In other words, decode unit 204 identifies the command to be performed, as well as operands on which the command is to be applied. Issue unit 206 sends the decoded instruction to a unit for execution such as, for example, execution unit 210.

Execution unit 210 is an example of a unit that executes the instruction received from issue unit 206. Execution unit 210 performs operations and calculations called for by the instruction. For example, execution unit 210 may include internal units, such as a floating point unit, an arithmetic logic unit (ALU), or some other unit. Completion unit 212 validates the operations in the program order for instructions that may be executed out of order by execution unit 210. Branch unit 208 handles branches in instructions.

Cache array 216 contains sets for data needed by processor system 200. These sets are also called ways and are also like columns in the array. In these examples, cache array 216 is an L2 cache. LRU array 218 holds bits for an N-way set associative cache. Set associative cache is a cache that has different data in a secondary memory that can map to the same cache entry. In an 8-way set associative cache, there are 8 different ways or sets per entry. Therefore, there can be 8 different data that map to the same entry. Each bit in LRU array 218 represents one interior node of a binary tree with leaves that represent the least recently used information for each way or set for the corresponding cache entry.

The illustrative embodiments are used to prolong the amount of time critical data structures and the corresponding data is retained in cache array 216. LRU control 220 controls aspects of the illustrative embodiments used to manage the data stored in cache array 216. Critical structure logic 226 contains the cache priority table which lists the critical data structures address, size, and starting priority. LRU array 218 includes a priority level or value, which starts at zero for non-critical data structures and uses the starting value from the cache priority table for critical data structures. For the addresses identified as critical by an application, LRU control 220 ages the data more slowly than normal. As a result, the critical data remains in cache array 216 longer than if the age of the data was increased at the normal rate.

In the illustrative embodiments, the information used to age critical data structures, such as address, size, and starting priority level of critical structures, may be specified by a cache priority subroutine and cache priority table as described in FIG. 4. The cache priority subroutine may be called by the operating system or by an individual application. The priority level may be used as a factor to proportionately age the critical data. In one example, the starting priority of a critical structure may be 8, indicating that the portion of the cache that stores the critical structure is aged at ⅛ the normal aging speed. The priority level may also represent a percentage of the normal aging speed, such as eighty percent of the normal aging speed.

Directory array 224 stores the cache coherence information, real address, and valid bit for the data in the corresponding cache entry in cache array 216. This array also has the same set-associative structure as cache array 216. For example, in an 8-way set associative cache, directory array 224 also has 8 ways. A way is also referred to as a set. This directory has a one-to-one match. Each time cache array 216 is accessed, directory array 224 will be accessed at the same time to determine if a cache hit or miss occurs and if the entry is valid.

Main memory unit 230 contains instructions and data that may be fetched or retrieved by processor system 200 for execution. In a case in which the data has not been fetched to cache array 216, bus control unit 232 performs as the traffic controller for the bus to arbiter requests and responses from the devices attached to the bus. For example, execution unit 210 may send a request and an address to memory subsystem 214 when a miss occurs in a L1 data cache (not shown) in execution unit 210. As a result, execution unit 210 causes L2 load and store queue control 222 to access LRU array 218, directory array 224 and cache array 216. The data in directory array 224 can be brought in by a cache miss in the L1 cache. Directory array 224 returns the data to indicate whether the data requested in the miss in the L1 cache is located in cache array 216, which serves as an L2 cache in this example. The data returned from directory array 224 includes a hit or miss; the data in the way of the cache entry is valid or invalid; and what memory coherence state of the entry, such as share, exclusive, modify. LRU array 218 returns LRU data to LRU control 220.

If a request for data results in a hit in directory array 224, LRU control 220 updates the LRU data stored in LRU array 218. In this case, cache array 216 contains the data and has no other information. Directory array 224 can be viewed as the array holding all other information in the cache array, such as address, validity, and cache coherence state. When there is an L1 cache miss request with address to access the directory and cache array, if the address matches with the address that is stored in the corresponding entry in directory array 224, that means a hit is present in the L2 cache array. Otherwise, a miss occurs. This update to the LRU data is the most and least recently used set in the L2 cache, cache array 216. LRU control 220 updates the LRU data from a binary tree scheme, described herein, by writing back to LRU array 218. Cache array 216 returns data to execution unit 210 in response to the hit on directory array 224.

A miss in directory array 224 results in execution unit 210 placing the request into L2 load and store control 222. Requests remain in this component until L2 load and store queue control 222 retrieves data from host bus 228. In response to this miss, LRU control 220 updates the LRU data from the binary tree scheme by writing back to LRU array 218. This update of LRU data contains the most and least recently used cache set in cache array 216. Once miss data returns to the L2 cache from host bus 228, LRU control 220 also forwards this data back to the L1 cache and execution unit 210.

In another illustrative embodiment, LRU control 220 and critical structure logic 226 may be implemented in a single LRU control element.

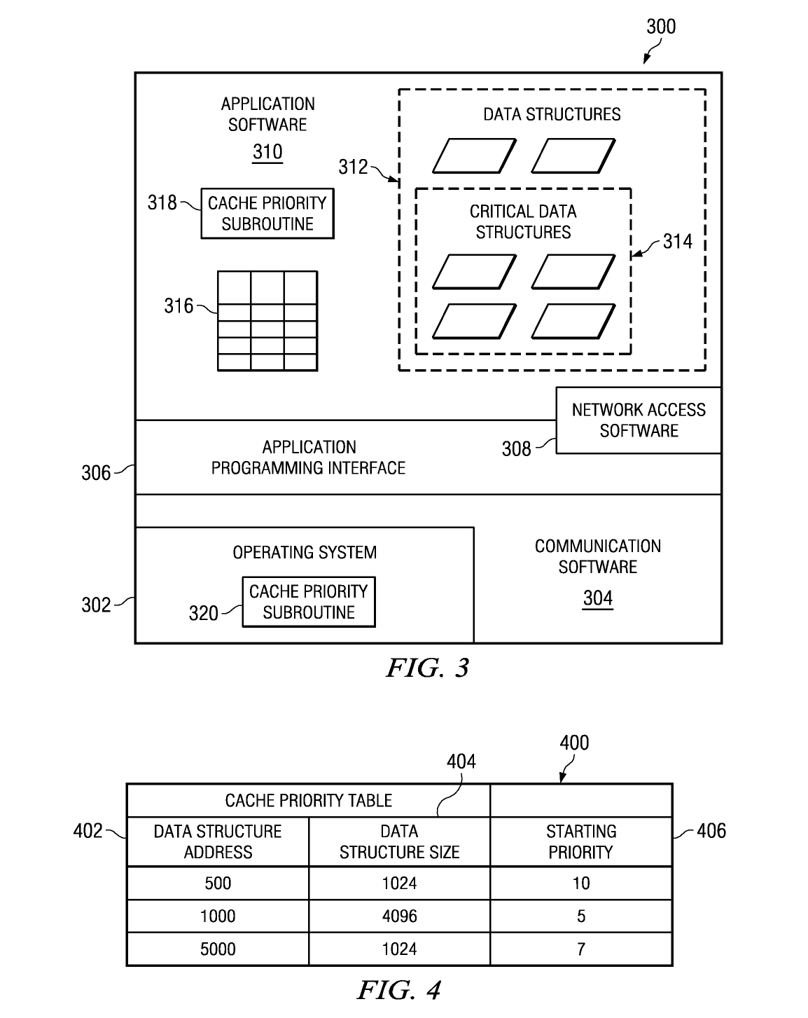

Turning to FIG. 3, typical software architecture for a server-client system is depicted in accordance with an illustrative embodiment. Software architecture 300 is an exemplary software system including various modules. The server or client may be a data processing system, such as data processing system 100 of FIG. 1. At the lowest level, operating system 302 is utilized to provide high-level functionality to the user and to other software. Such an operating system typically includes a basic input output system (BIOS). Communication software 304 provides communications through an external port to a network, such as the Internet via a physical communications link by either directly invoking operating system functionality or indirectly bypassing the operating system to access the hardware for communications over the network.

Application programming interface (API) 306 allows the user of the system, an individual, or a software routine to invoke system capabilities using a standard consistent interface without concern for how the particular functionality is implemented. Network access software 308 represents any software available for allowing the system to access a network. This access may be to a network, such as a local area network (LAN), wide area network (WAN), or the Internet. With the Internet, this software may include programs, such as Web browsers.

Application software 310 represents any number of software applications designed to react to data through the communications port to provide the desired functionality the user seeks. Applications at this level may include those necessary to handle data, video, graphics, photos, or text which can be accessed by users of the Internet. The mechanism of the illustrative embodiments may be implemented within communication software 304 in these examples.

Application software 310 includes data structures 312. Some of data structures 312 are critical data structures 314. Critical data structures 314 are data structures that are critical for the performance of application software 310. As a result, critical data structures 314 need to stay in a cache, such as cache array 216 of FIG. 2, to ensure that application software 310 achieves optimal performance. Critical data structures 314 may include data that is frequently accessed or data that needs to be accessed efficiently at any given time. Keeping data that is frequently accessed in cache longer improves performance because that data is supplied to the central processing unit more quickly from cache than from main memory.

In one illustrative embodiment, a software application developer may specify critical data structures 314 within data structures 312 of application software 310. Information regarding the address, size, and priority level or critical rating of each of critical data structures 314 is stored in cache priority table 316. Application software 310 also includes a code or call to initiate cache priority subroutine 318 when application software 310 is started so that the values of cache priority table 316 may be stored in a hardware cache priority table. The hardware cache priority table may be part of LRU control 220 or critical structure logic 226 of FIG. 2.

Operating system 302 includes cache priority subroutine 320 for calling the new cache priority hardware instruction. Syntax for cache priority subroutines 318 and 320 may be specified by:

Set_cache_priority(address, size, starting_priority)

The parameters of cache priority subroutines 318 and 320 may include address, size, and starting_priority, information which may be stored in cache priority table 316, which is further described in FIG. 4.

FIG. 4 is an exemplary cache priority table in accordance with the illustrative embodiments. Cache priority table 400 is a table, such as cache priority table 316 of FIG. 3. Cache priority table 400 may be part of application software 310 and includes information that may be used by a cache priority subroutine, such as cache priority subroutines 318 and 320, all of FIG. 3. Cache priority table 400 may include columns for data structure address 402, data structure size 404, and starting priority 406.

Data structure address 402 is the starting address of a critical data structure, such as critical data structures 314 of FIG. 3. Data structure size 404 is the size, in bytes, of the critical data structure. Starting priority 406 is the initial cache priority level of the critical data structure and indicates how critical the data is. In one example, the minimum starting priority is zero and the maximum starting priority is ten. Starting priority 406 may be modified as needed.

In one example, if the data is assigned starting priority 406 of two, the cache would age the data at half the rate as non-critical data. If the data were given a starting priority 406 or critical rating of ten, the cache would age the data at 1/10^{th} the rate of non-critical data. If the data is assigned a starting priority 406 of one, the data may be aged like all other data in the cache without any preferential aging treatment. Correspondingly, cache priority level of zero may be used to indicate that the cache will be aged according to normal or default settings.

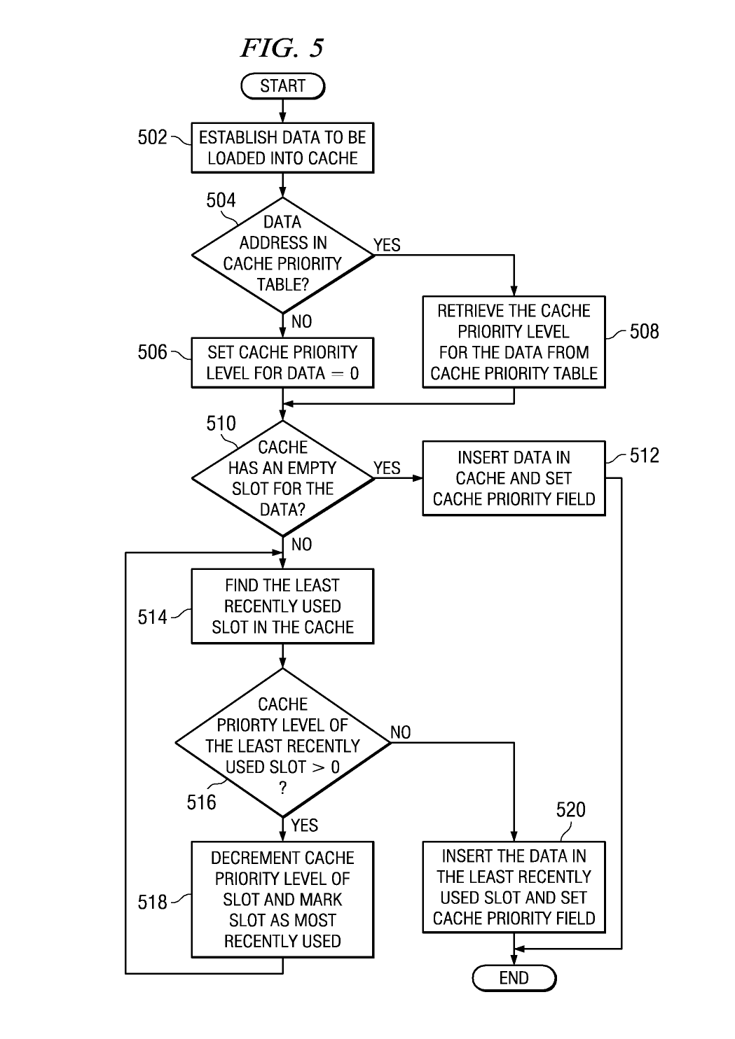

FIG. 5 is a flowchart for a process for establishing cache priority information in accordance with the illustrative embodiments. The process begins by establishing the data to be loaded into cache (step 502). The data to be loaded into cache is established by fetch unit 202 of FIG. 2. The data may be received from application software 310 of FIG. 3. The cache may be cache array 216 of FIG. 2. Next, the process determines whether the data address is in a cache priority table (step 504). The determination of step 504 is performed by critical structure logic 226 of FIG. 2 based on cache priority table 316 of FIG. 3 stored in the critical structure logic.

If the process determines the data address is not in the cache priority table, the process sets the cache priority level for the data equal to zero (step 506). Zero indicates that the data is of the lowest priority and ages according to normal or default settings. If the process determines the data address is in the cache priority table in step 504, the process retrieves the cache priority level for the data from the cache priority table (step 508). Step 508 may be performed by critical structure logic 226 of FIG. 2 based on starting priority 406 of cache priority table 400, both of FIG. 4.

Next, the process determines whether the cache has an empty slot for the data (step 510). The slot is a designated portion of the cache. Slots of the cache are used to store the data and the summed capacity of each slot indicates how much data the cache may hold. For example, a 1 Mb cache may include slots of 128 kb. Step 510 may be performed by LRU control 220 based on data and available slots in LRU array 218, both of FIG. 2. If the process determines the cache has an empty slot for data, the process inserts the data in cache and sets the cache priority field (step 512) with the process terminating thereafter. The cache priority field stores the cache priority level for the data, similarly to starting priority 406 of FIG. 4. The data is inserted by LRU control 220 into cache array 216, both of FIG. 2. If the process determines the cache does not have an empty slot for the data in step 510, the process finds the least recently used slot in the cache (step 514).

Next, the process determines whether the cache priority level of the least recently used (LRU) slot is greater than zero (step 516). Step 516 is performed by critical structure logic 226 of FIG. 2. If the process determines the cache priority level of the least recently used slot is greater than zero, the process decrements the cache priority level of the slot and marks the slot as most recently used (MRU) (step 518). Step 518 is performed by critical structure logic 226 of FIG. 2. Next, the process finds the least recently used slot in the cache (step 514). Step 514 is performed by LRU control 220 of FIG. 2. Steps 518 and 514 are repeated until the cache priority level of the least recently used slot is not greater than zero in step 516. If the process determines the cache priority level of the least recently used slot is not greater than zero, then the process inserts the data in the least recently used slot and sets the cache priority field (step 520) with the process terminating thereafter.

The illustrative embodiments provide a computer implemented method, apparatus, and computer usable program code for managing data in a cache. Hardware instructions specify critical data structures within an application. The hardware instructions particularly specify the addresses and sizes of data that is to be aged differently. The hardware instruction may also include a cache priority field specifying how the critical data is to be aged. By keeping the data from the critical data structures in cache for prolonged amounts of time, the application is able to achieve optimal performance.

The illustrative embodiments can take the form of an entirely hardware embodiment, an entirely software embodiment or an embodiment containing both hardware and software elements. The illustrative embodiments are implemented in software, which includes but is not limited to firmware, resident software, microcode, etc.

Furthermore, the illustrative embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the illustrative embodiments have been presented for purposes of illustration and description, and is not intended to be exhaustive or limited to the illustrative embodiments in the form disclosed. Many modifications and variations will be apparent to those of ordinary skill in the art. The embodiment was chosen and described in order to best explain the principles of the illustrative embodiments, the practical application, and to enable others of ordinary skill in the art to understand the illustrative embodiments for various embodiments with various modifications as are suited to the particular use contemplated.

What is claimed is:

1. A computer implemented method for managing data in a cache, the computer implemented method comprising:
identifying the data in the cache that has been designated by an application to form identified data; and
responsive to identifying the data in the cache, aging the identified data in the cache at a slower rate than other data in the cache that is undesignated for slower aging.

2. The computer implemented method of claim 1, wherein the identifying step comprises:
determining whether a data address in which the data is located is associated with a cache priority level indicating the data is critical data.

3. The computer implemented method of claim 2, wherein the aging step comprises:
responsive to determining the data address is associated with the cache priority level, finding a least recently used slot in the cache; and
responsive to the cache priority level of the data address being greater than a priority level of the least recently used slot, inserting the data of the data address in the least recently used slot.

4. The computer implemented method of claim 1 further comprising:
receiving an identification of the data in the cache that has been designated by the application through execution of an instruction in the application, wherein the instruction includes a priority rating for the data.

5. The computer implemented method of claim 2, wherein the determining step further comprises:
determining whether the data address is present in a cache priority table;
responsive to determining the data address is present in the cache priority table, retrieving the cache priority level associated with the data address from the cache priority table.

6. The computer implemented method of claim 2, further comprising:
establishing the cache priority level for critical data structures and corresponding data addresses, wherein the cache priority level indicates importance of the data within the data address.

7. The computer implemented method of claim 6, wherein a cache priority subroutine establishes the critical data structures, wherein the critical data structures indicate sizes and addresses of the critical data.

8. The computer implemented method of claim 5, wherein the cache priority table specifies address, size, and starting priority of the critical data.

9. The computer implemented method of claim 1, wherein the identifying and aging steps are performed by a least recently used control.

10. The computer implemented method of claim 2, further comprising:
responsive to a determining that the data to be stored in the cache does not have a priority level, setting the cache priority level for the data equal to zero.

11. The computer implemented method of claim 1, further comprising:
responsive to determining the cache has an empty slot for the data, inserting the data in the cache and setting a cache priority field.

12. The computer implemented method of claim 2, further comprising:
responsive to the cache priority level of the data being greater than a priority level of the least recently used slot, decrementing the priority level of the least recently used slot and marking the slot as most recently used.

13. The computer implemented method of claim 2, further comprising:
aging the data of the data address proportionate to the cache priority level, wherein the data with a higher critical rating is aged more slowly than the data with a lower critical rating.

14. A caching system comprising:
a cache array for caching data, wherein; a least recently used array, wherein the least recently used array determines whether a data address is associated with a cache priority level, finds a least recently used slot in the cache array in response to a determination that the data address is associated with the cache priority level, inserts the data of the data address in the least recently used slot of the cache array in response to the cache priority level of the data being greater than a priority level of the least recently used slot, and sets the cache priority level for the data for controlling contents of the cache based on the cache priority level.

15. The caching system of claim 14, further comprising:
a cache priority table within the least recently used array for determining the cache priority level.

16. The caching system of claim 15, wherein the least recently used array includes a logic unit for using the cache priority level to age the contents of the cache based on the cache priority level.

17. A computer program product comprising a computer usable medium including computer usable program code for managing data in a cache, the computer program product comprising:
computer usable program code for determining whether a data address is associated with a cache priority level;
computer usable program code responsive to determining the data address is associated with the cache priority level, for finding a least recently used slot in the cache;
computer usable program code responsive to the cache priority level of the data address being greater than a priority level of the least recently used slot, for inserting the data of the data address in the least recently used slot; and
computer usable program code for setting the cache priority level for the data address for controlling contents of the cache based on the cache priority level.

18. The computer program product of claim 17, further comprising:
computer usable program code responsive to determining the cache has an empty slot for the data, for inserting the data in the cache and setting a cache priority field.

19. The computer program product of claim 17, further comprising:
computer usable program code responsive to the cache priority level of the data being greater than the priority level of the least recently used slot, for decrementing the priority level of the least recently used slot and marking the least recently used slot as most recently used.

20. A computer implemented method for managing data in a cache, the computer implemented method comprising:
determining whether a data address is present in a cache priority table;
responsive to the determination that the data address is present in the cache priority table, retrieving a cache priority level from the cache priority table for the data in the data address;
finding a least recently used slot in the cache;
responsive to the cache priority level of the data being greater than a priority level of the least recently used slot, inserting the data of the data address in the least recently used slot;
setting the cache priority level for the data address for controlling contents of the cache based on the priority level; and
aging the data as a factor of the cache priority level.
